(19) United States
(12) Patent Application Publication
(10) Pub. No.: US 2026/0024761 A1
(43) Pub. Date: Jan. 22, 2026

(54) Positive Electrode Active Material, Positive Electrode and Lithium Secondary Battery Including the Same

(71) Applicants: LG Energy Solution, Ltd., Seoul (KR); Postech Research and Business Development Foundation, Pohang-si (KR)

(72) Inventors: So Ra Baek, Daejeon (KR); Chi Ho Jo, Daejeon (KR); Yeong Deok Yoon, Daejeon (KR); Hyeon Jin Cho, Daejeon (KR); Dong Wan Yoo, Daejeon (KR); Si Young Choi, Pohang-si (KR); Gi Yeop Kim, Pohang-si (KR); Jeong Min Kim, Pohang-si (KR)

(73) Assignees: LG Energy Solution, Ltd., Seoul (KR); Postech Research and Business Development Foundation, Pohang-si (KR)

(21) Appl. No.: 19/272,181

(22) Filed: Jul. 17, 2025

(30) Foreign Application Priority Data
Jul. 19, 2024 (KR) 10-2024-0095995

(51) Int. Cl. H01M 4/525; C01G 53/504; H01M 4/02

(52) U.S. Cl. CPC H01M 4/525; C01G 53/504; C01P 2002/50; C01P 2004/04; C01P 2004/61; C01P 2006/11; C01P 2006/12; C01P 2006/40; H01M 2004/021

(57) ABSTRACT

A positive electrode active material includes a lithium transition metal oxide including Ni in an amount of about 60 at % or more among the transition metals excluding lithium, and is in a form of a single particle made up of one nodule or in a form of a pseudo-single particle that is a complex of 30 or fewer nodules. A proportion of a (003) plane with respect to a total surface area of the positive electrode active material is 40% or less.

### CROSS-REFERENCE TO RELATED APPLICATIONS

This application is based on and claims priority from Korean Patent Application No. 10-2024-0095995 filed on Jul. 19, 2024, with the Korean Intellectual Property Office, the disclosure of which is incorporated herein in its entirety by reference.

### TECHNICAL FIELD

The present disclosure relates to a positive electrode active material for a lithium secondary battery, a positive electrode and a lithium secondary battery including the same.

### BACKGROUND

In recent years, with the rapid proliferation of electronic devices using batteries such as mobile phones, laptops, computers, and electric vehicles, the demand for small, lightweight, and relatively high-capacity secondary batteries has rapidly increased. For example, lithium secondary batteries are gaining attention as a power source for mobile devices due to their light weight and high energy density. Thus, many researches and developments are progressing to improve the performance of lithium secondary batteries.

### SUMMARY

The present disclosure provides a positive electrode active material that is capable of suppressing particle fracture and crack generation during electrode manufacturing and charge/discharge processes, and that exhibits excellent rolling density.

In addition, the present disclosure provides a positive electrode and a lithium secondary battery having improved output characteristics and long-term cycle performance by including a positive electrode active material with excellent lithium ion mobility.

In an aspect, the present disclosure provides a positive electrode active material including a lithium transition metal oxide including Ni in an amount of about 60 at % or more among the transition metals excluding lithium, in a form of a single particle made up of one nodule or in a form of a pseudo-single particle that is a complex of 30 or fewer nodules, in which a proportion of a (003) plane with respect to a total surface area of the positive electrode active material is 40% or less.

In another aspect, the present disclosure provides a positive electrode including the positive electrode active material according to the present disclosure.

In still another aspect, the present disclosure provides a lithium secondary battery including the positive electrode according to the present disclosure.

The positive electrode active material for a lithium secondary battery according to the present disclosure has a single-particle and/or pseudo-single-particle form with excellent particle strength, thereby suppressing particle fracture and crack generation during electrode manufacturing and charge/discharge processes.

In addition, the positive electrode active material for a lithium secondary battery according to the present disclosure allows dense particle packing, thereby enabling the formation of a positive electrode with high rolling density, which in turn contributes to a high energy density electrode.

Furthermore, the positive electrode active material of the present disclosure exhibits high lithium ion activity at the surface, thereby enabling the provision of a lithium secondary battery with excellent output characteristics.

Since the positive electrode active material of the present disclosure has a uniform lithium ion activity level on the surface, structural degradation in a specific portion may be suppressed, resulting in excellent long-term cycle performance of a lithium secondary battery including the positive electrode active material of the present disclosure.

### BRIEF DESCRIPTION OF THE DRAWINGS

The following drawings attached hereto exemplify embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a flowchart illustrating a method for preparing a positive electrode active material according to one embodiment of the present disclosure.

FIG. 2 illustrates a structure of a positive electrode employing the positive electrode active material according to one embodiment of the present disclosure.

FIG. 3 illustrates the structure of a lithium secondary battery according to one embodiment of the present disclosure.

FIG. 4 is a TEM (Transmission Electron Microscope) image of a particle included in the positive electrode active material prepared in Example 1.

FIG. 5 is a TEM (Transmission Electron Microscope) image of a particle included in the positive electrode active material prepared in Example 2.

FIG. 6 is a TEM (Transmission Electron Microscope) image of a particle included in the positive electrode active material prepared in Example 3.

FIG. 7 is a TEM (Transmission Electron Microscope) image of a particle included in the positive electrode active material prepared in Comparative Example 1.

FIG. 8 is a TEM (Transmission Electron Microscope) image of a particle included in the positive electrode active material prepared in Comparative Example 2.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

As used herein, it should be understood that the terms “comprise,” “include,” or “have” are intended to specify the presence of a feature, number, step, component, or combination thereof, but do not exclude in advance the possibility of the presence or addition of one or more other features, numbers, steps, components, or combinations thereof.

In the present disclosure, the term “secondary particle” refers to a particle formed by aggregation of tens to hundreds of primary particles. For example, the secondary particle is an aggregate of 50 or more primary particles.

In the present disclosure, the term “particle” may include any one or all of a single particle, a pseudo-single particle, a primary particle, a nodule, and a secondary particle.

In a lithium secondary battery, electric energy is generated through oxidation and reduction reactions that occur when lithium ions are intercalated into and deintercalated from the positive and negative electrodes, in a state where an organic electrolyte or a polymer electrolyte is filled between the positive electrode and the negative electrode, which are made up of active materials capable of intercalating and deintercalating lithium ions.

Examples of the positive electrode active material for a lithium secondary battery include lithium cobalt oxide (LiCoO₂), lithium nickel oxides (LiNiO₂), lithium manganese oxide (such as LiMnO₂ or LiMn₂O₄), and lithium iron phosphate compound (LiFePO₄). Among these, lithium cobalt oxide (LiCoO₂) has been widely used due to its high operating voltage and excellent capacity characteristics, and has been applied as a high-voltage positive electrode active material. However, due to rising cobalt (Co) prices and instability in the supply, there are limitations to large-scale use as a power source for applications such as electric vehicles. As a result, there is an increasing need to develop alternative positive electrode active materials.

Accordingly, nickel-cobalt-manganese (NCM)-based lithium composite transition have been developed, in which some of cobalt (Co) is substituted with nickel (Ni) and manganese (Mn). In the related art, lithium nickel cobalt manganese oxides have generally been in the form of spherical secondary particles formed by aggregation of several tens to several hundreds of primary particles. However, in the case of lithium nickel cobalt manganese oxides having a secondary particle structure in which a large number of primary particles are aggregated, there is a problem in that particle fracture is likely to occur during the rolling process in positive electrode manufacturing due to detachment of the primary particles, and cracks may form inside the particles during charge and discharge process. When particle fracture or cracking occurs in the positive electrode active material, the contact area with the electrolyte increases, leading to side reactions with the electrolyte, which in turn causes gas generation and degradation of the active material, thereby deteriorating the life characteristics. In addition, since fine particles are generated by fracture during rolling, there is a problem of low rolling density and low energy density.

In consideration of the above issues, the present disclosure provides a positive electrode active material having a single-particle and/or pseudo-single-particle form with excellent particle strength, which may suppress particle fracture and crack generation during electrode manufacturing and charge/discharge processes. Furthermore, the present disclosure provides a positive electrode active material having a high and uniform level of lithium ion activity at the surface, as well as a positive electrode and a lithium secondary battery including the same.

### Positive Electrode Active Material

In one embodiment of the present disclosure, the positive electrode active material includes Ni in an amount of about 60 at % or more among transition metals excluding lithium, and is in the form of a single particle made up of one nodule or a pseudo-single particle that is a complex of 30 or fewer nodules.

In the present disclosure, “at %” means atomic percent, which represents a ratio of the number of atoms of a specific element to the total number of atoms.

In the present disclosure, the “single particle” is a particle made up of one single nodule.

In the present disclosure, the term “nodule” refers to a unit particle that is either a single crystal without a crystalline grain boundary, or a polycrystal in which no apparent grain boundary is observed under a scanning electron microscope (SEM) at a magnification of 5,000 to 20,000 times. In the present disclosure, the term “pseudo-single particle” refers to a composite particle made up of 30 or fewer nodules. The positive electrode active material of the present disclosure exhibits reduced particle fracture and crack generation during rolling in electrode manufacturing. Accordingly, when applied to a secondary battery, the positive electrode active material may implement excellent high-temperature life characteristics due to reduced gas generation and degradation of the active material caused by side reactions with the electrolyte.

In one embodiment of the present disclosure, the positive electrode active material has a proportion of the (003) plane of 40% or less with respect to the total surface area of the positive electrode active material. In lithium transition metal oxides, various surface crystal planes such as (003), (102), (104), and (012) are present. In the present disclosure, the surface morphology is controlled by adjusting the proportion of the (003) plane among the total surface crystal planes.

In the case of a positive electrode active material having a single-particle and/or pseudo-single-particle form, it is more difficult to control the surface morphology compared to conventional secondary particles, because the primary particles are larger in size and require a large amount of reaction heat for particle growth.

In the present disclosure, the surface morphology of the positive electrode active material having a single-particle and/or pseudo-single-particle form is controlled by adjusting the proportion of the (003) plane among the surface crystal planes. In conventional secondary particles, the (003) plane, which has low electrochemical lithium ion activity, is distributed at a high proportion among the surface crystal planes, thereby improving the structural stability of the positive electrode active material. In conventional secondary particles, even when the (003) plane is distributed at a high proportion among the surface crystal planes, intercalation and deintercalation of lithium ions are facilitated due to the large specific surface area, so that no deterioration in output characteristics occurs, and rather, an improvement in cycle life characteristics may be achieved.

In contrast, in the positive electrode active material having a single-particle and/or pseudo-single-particle form, when the proportion of the (003) plane exposed on the surface is high, the electrochemical lithium ion activity at the surface becomes low, resulting in poor lithium ion diffusion characteristics. Accordingly, as charge and discharge cycles are repeated, the non-uniformity of lithium ions inside the particles becomes more severe, leading to a tendency for structural degradation to become more pronounced.

In the positive electrode active material of the present disclosure, the proportion of the (003) plane with respect to the total surface area of the positive electrode active material may be about 40% or less, 38% or less, 35% or less, 30% or less, 28% or less, or 25% or less. The proportion of the (003) plane with respect to the total surface area of the positive electrode active material may also be greater than about 0%, or 5% or more, 10% or more, 15% or more, or 20% or more.

In the positive electrode active material of the present disclosure, the proportion of the (102) plane with respect to the total surface area of the positive electrode active material may be about 20% to 80%, for example, about 30% to 70%, or about 40% to 60%.

In the positive electrode active material of the present disclosure, the proportion of the (104) plane with respect to the total surface area of the positive electrode active material may be about 20% to 80%, for example, about 30% to 70%, or about 40% to 60%.

The surface crystal planes of the positive electrode active material may be analyzed by TEM analysis and SADP imaging. For example, the proportion of a specific surface crystal plane may be measured for 300 particles of the positive electrode active material, and an arithmetic average thereof may be calculated. The TEM analysis may be performed using selected area diffraction pattern (SADP) and fast Fourier transform (FFT).

According to one embodiment, the positive electrode active material is prepared as a TEM specimen and set in a TEM instrument. The specimen is then tilted to adjust the beam transmission direction, and the particle morphology is observed in STEM mode. Thereafter, when the inter-plane distance (d-spacing) and diffraction angle obtained through SADP imaging or FFT analysis correspond to those of the (003) plane, the corresponding direction is defined as the (003) plane. This procedure is repeated for 300 particles of the positive electrode active material to determine the proportion of the (003) plane with respect to the total surface area of the positive electrode active material.

The ratio of the major axis to the minor axis of the particles of the positive electrode active material according to the present disclosure may be about 1.0 to 1.8, for example, about 1.0 to 1.5, or about 1.0 to 1.4. When the ratio of the major axis to the minor axis of the particles of the positive electrode active material satisfies the above range, the tap density of the positive electrode active material may be improved. Accordingly, the rolling property of the positive electrode including the positive electrode active material is improved, and the energy density of the lithium secondary battery including the positive electrode may be enhanced.

In the present disclosure, the “major axis” and “minor axis” of the positive electrode active material refer to values derived from the maximum diameter (major axis) and minimum diameter (minor axis) of particles, obtained by two-dimensionalizing TEM (Transmission Electron Microscope) images of the positive electrode active material particles and analyzing the two-dimensionalized images using an image analysis program. These values represent an average of several tens to several hundreds of particles, and in the present disclosure, specifically, the average of 300 particles.

The lithium transition metal oxide included in the positive electrode active material may have a composition represented by Formula 1:

$$L {i}_{a} {Ni}_{b} {Co}_{c} {M}_{d}^{1} {M}_{e}^{2} {O}_{2} \qquad [ Formula 1 ]$$

In Formula 1, M¹ may be Mn, Al, or a combination thereof, and M² may be at least one selected from Zr, W, Y, Ba, Ca, Ti, Mg, Ta, and Nb.

The variable “a” represents a molar ratio of lithium in the nickel-based lithium composite metal oxide, and may be in the range of 0.80≤a≤1.2, for example, 0.95≤a≤1.08, or 1≤a≤1.08.

The variable “b” represents a molar ratio of nickel among the metal elements excluding lithium in the nickel-based lithium composite metal oxide, and may be in the range of 0.6≤b≤0.99, 0.80≤b≤0.95, or 0.83≤b≤0.93. When the nickel content satisfies the above range, the high-capacity characteristic may be implemented.

The variable “c” represents a molar ratio of cobalt among the metal elements excluding lithium in the nickel-based lithium composite metal oxide, and may be in the range of 0<c<0.40, 0<c<0.20, 0<c≤0.15, or 0.01≤c≤0.10.

The variable “d” represents a molar ratio of M¹ among the metal elements excluding lithium in the nickel-based lithium composite metal oxide, and may be in the range of 0<d<0.40, 0<d<0.20, 0<d≤0.15, or 0.01≤d≤0.10.

The variable “e” represents a molar ratio of M² among the metal elements excluding lithium in the nickel-based lithium composite metal oxide, and may be in the range of 0≤e≤0.10, or 0≤e≤0.05.

The powder resistance of the positive electrode active material of the present disclosure may be about 0.00005Ω to 0.00050Ω, for example, about 0.00010Ω to 0.00045Ω, or about 0.00015 Ω to 0.00040Ω. The powder resistance may be measured using a powder resistance measurement device, such as HPRM-1000 (manufactured by Hantech Co., Ltd.). Since powder resistance mainly reflects the electrical properties at the surface of the positive electrode active material, such powder resistance values may be obtained by controlling the surface crystal planes of the positive electrode active material as in the present disclosure.

The average particle diameter (D₅₀) of the positive electrode active material according to the present disclosure may be about 2 μm to 8 μm, for example, about 2 μm to 7 μm, or about 2 μm to 6 μm. In the present disclosure, “D₅₀” refers to the particle size at the 50% point in the volume cumulative particle size distribution of the positive electrode active material powder. The average particle diameter (or median particle size) D₅₀ may be measured using a laser diffraction method. For example, the average particle size D₅₀ may be measured by dispersing the positive electrode active material powder in a dispersant, introducing the dispersion into a commercially available laser diffraction particle size measurement device (e.g., Microtrac MT 3000), irradiating the dispersion with ultrasonic waves of about 28 kHz at a power of 60 W, obtaining a volume accumulation particle size distribution graph, and then finding the particle size corresponding to 50% of the volume accumulation.

The specific surface area (BET) of the positive electrode active material according to the present disclosure may be about 0.3 m²/g to 1.2 m²/g, for example, about 0.4 m²/g to 1.1 m²/g, or about 0.5 m²/g to 0.9 m²/g. In the present disclosure, the term “specific surface area BET” refers to a value measured by the Brunauer-Emmett-Teller (BET) method, and is calculated from the amount of nitrogen gas adsorbed at a liquid nitrogen temperature (77 K) using a BELSORP-mini II instrument manufactured by BEL Japan.

The tap density of the positive electrode active material according to the present disclosure may be about 1.5 g/cm³ to 2.9 g/cm³, for example, about 1.7 g/cm³ to 2.7 g/cm³, or about 1.8 g/cm³ to 2.6 g/cm³. The tap density may be measured, for example, by using a tap density tester (Micromeritics GeoPyc 1365), in which 5 g of the positive electrode active material is charged and then vibrated until a horizontal force of 108 N is applied.

### Method for Preparing Positive Electrode Active Material

Next, a method for preparing the positive electrode active material of the present disclosure will be described.

In the positive electrode active material of the present disclosure, various conditions in the preparing process may affect the control of the proportion of the (003) plane among the surface crystal planes.

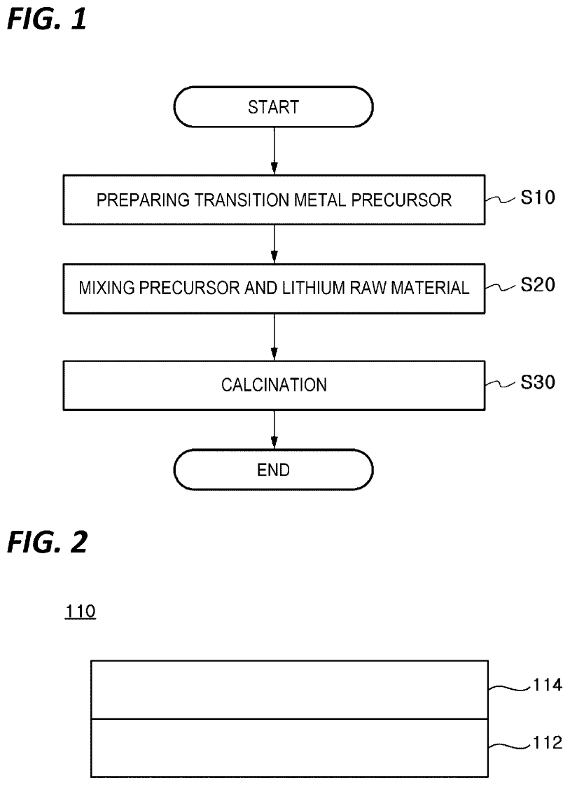

Referring to FIG. 1, a method for preparing a positive electrode active material according to the present disclosure may include a step (S10) of mixing a transition metal precursor including nickel, cobalt, and manganese with a lithium raw material and then calcining the mixture.

In this case, the precursor for the positive electrode active material may be a commercially available nickel-cobalt-manganese-based hydroxide or may be prepared by a precursor synthesis method known in the art, such as a co-precipitation method.

For example, the precursor of the positive electrode active material may be prepared by first preparing a transition metal-containing solution including cations of nickel (Ni), cobalt (Co), and M¹, and then adding a chelating agent containing ammonium cations and a basic aqueous solution to the transition metal-containing solution to induce a co-precipitation reaction.

The transition metal-containing solution may include a nickel-containing raw material, a cobalt-containing raw material, and an M¹-containing raw material. The M¹-containing raw material may include a manganese-containing raw material and/or an aluminum-containing raw material.

The nickel-containing raw material may be, for example, a nickel-containing acetate, nitrate, sulfate, halide, sulfide, hydroxide, oxide, or oxyhydroxide. Examples thereof include, but are not limited thereto, Ni(OH)₂, NiO, NiOOH, NiCO₃·2Ni(OH)₂·4H₂O, NiC₂O₂·2H₂O, Ni(NO₃)₂·6H₂O, NiSO₄, NiSO₄·6H₂O, a nickel fatty acid salt, a nickel halide, and a combination thereof.

The cobalt-containing raw material may be a cobalt-containing acetate, nitrate, sulfate, halide, sulfide, hydroxide, oxide, or oxyhydroxide. Examples thereof include, but are not limited thereto, Co(OH)₂, CoOOH, Co(OCOCH₃)₂·4H₂O, Co(NO₃)₂·6H₂O, CoSO₄, Co(SO₄)₂·7H₂O, or a combination thereof.

The manganese-containing raw material may be, for example, a manganese-containing acetate, nitrate, sulfate, halide, sulfide, hydroxide, oxide, oxyhydroxide, or a combination thereof. Examples thereof include, but are not limited thereto, manganese oxide such as Mn₂O₃, MnO₂, or Mn₃O₄; a manganese salt such as MnCO₃, Mn(NO₃)₂, MnSO₄, manganese acetate, manganese dicarboxylate, manganese citrate, or manganese fatty acid salt; manganese oxyhydroxide; manganese chloride; or a combination thereof.

The aluminum-containing raw material may be, for example, Al₂O₃, Al(OH)₃, Al(NO₃)₃, Al₂(SO₄)₃, (HO)₂AlCH₃CO₂, HOAl(CH₃CO₂)₂, Al(CH₃CO₂)₃, an aluminum halide, or a combination thereof.

The transition metal-containing solution may be prepared by adding a nickel-containing raw material, a cobalt-containing raw material, and an M¹-containing raw material to a solvent, such as water or a mixed solvent of water and an organic solvent that is uniformly miscible with water (e.g., alcohol), or may be prepared by mixing an aqueous solution of a nickel-containing raw material, an aqueous solution of a cobalt-containing raw material, and an M¹-containing raw material.

The chelating agent containing ammonium cations may be, for example, NH₄OH, (NH₄)₂SO₄, NH₄NO₃, NH₄Cl, CH₃COONH₄, NH₄CO₃, or a combination thereof, but is not limited thereto. Meanwhile, the chelating agent may be used in the form of an aqueous solution, and in such a case, the solvent may be water or a mixture of water and an organic solvent that is uniformly miscible with water (e.g., alcohol).

The basic compound may be a hydroxide of an alkali metal or an alkaline earth metal such as NaOH, KOH, or Ca(OH)₂, a hydrate thereof, or a combination thereof. The basic compound may also be used in the form of an aqueous solution. In this case, the solvent may be water or a mixture of water and an organic solvent that is uniformly miscible with water (e.g., alcohol).

The basic compound may be used to control various conditions such as the pH of the reaction solution, the gas conditions during the co-precipitation reaction, the reaction temperature conditions during the co-precipitation, and the concentrations of the nickel-containing raw material, the cobalt-containing raw material, and the M¹-containing raw material. As a result, properties such as the composition and the BET specific surface area of the precursor of the positive electrode active material may be adjusted.

For example, the precursor of the positive electrode active material may have a composition represented by the following Formula 2.

$${Ni}_{x 1} {Co}_{y 1} {{Mn}_{z 1} ( OH )}_{2} \qquad [ Formula 2 ]$$

The variable “x1” represents a molar ratio of nickel among all metal elements in the transition metal hydroxide, and may be in the range of 0.6≤x1≤0.99, for example, 0.8≤x1≤0.98, 0.85≤x1≤0.98, or 0.88≤x1≤0.95. When the nickel content satisfies the above range, a positive electrode active material having high capacity characteristics may be produced.

The variable “y1” represents a molar ratio of cobalt among all metal elements in the transition metal hydroxide, and may be in the range of 0<y1<0.4, 0<y1<0.3, 0.01≤y1<0.2, 0.01≤y1<0.14, or 0.01≤y1<0.12.

The variable “z1” represents a molar ratio of manganese among all metal elements in the transition metal hydroxide, and may be in the range of 0≤z1≤0.4, 0.01≤z1≤0.3, 0.01≤z1≤0.2, or 0.01≤z1≤0.12.

The specific surface area (BET) of the precursor of the positive electrode active material may be about 15 m²/g to 35 m²/g, for example, about 17 m²/g to 30 m²/g, or about 19 m²/g to 27 m²/g. When the BET specific surface area of the precursor is large, thermal energy may be delivered into the interior of the particles during calcination, enabling uniform particle growth, and thus the degree of sphericity is improved, which is advantageous in achieving the surface crystal plane required in the present disclosure. However, when the BET specific surface area of the precursor of the positive electrode active material is excessively large, the thermal energy required for uniform particle growth also increases, which may make it difficult to control the surface crystal planes.

Thereafter, the precursor of the positive electrode active material and a lithium raw material may be mixed (S20).

The lithium raw material may include lithium-containing sulfates, nitrates, acetates, carbonates, oxalates, citrates, halides, hydroxides, or oxyhydroxides, and is not particularly limited as long as it is soluble in water. For example, the lithium raw material may be Li₂CO₃, LiNO₃, LiNO₂, LIOH, LIOH·H₂O, LiH, LIF, LiCl, LiBr, LiI, CH₃COOLi, Li₂O, Li₂SO₄, CH₃COOLi, or Li₃C₆H₅O₇, and one or more mixtures thereof may be used.

The precursor of the positive electrode active material and the lithium raw material may be mixed in a molar ratio of, for example, about 1:1, about 1:1.05, about 1:1.10, about 1:1.15, or about 1:1.20, but are not limited thereto.

Thereafter, the mixture may be calcined (S30). For example, the calcination may be performed in an air or oxygen atmosphere. The oxygen atmosphere may have an oxygen content of 60 vol % or more.

For example, the calcination may be carried out at a temperature of about 830° C. to 950° C., 840° C. to 940° C., or 850° C. to 930° C.

For example, the calcination may be performed for 10 to 28 hours, 11 to 27 hours, or 12 to 26 hours.

By adjusting the calcination conditions as described above, uniform particle growth becomes possible, which is advantageous for achieving the desired surface crystal plane in the present disclosure.

After the calcination process, the positive electrode active material in the form of powder may be obtained using, for example, a pulverizer.

### Positive Electrode

A positive electrode according to the present disclosure includes the above-described positive electrode active material of the present disclosure. Referring to FIG. 2, a positive electrode 110 may include a positive electrode current collector 112 and a positive electrode active material layer 114 formed on the positive electrode current collector 112. The positive electrode active material layer 114 includes the positive electrode active material powder according to the present disclosure. Since the positive electrode active material powder has been described above, detailed descriptions thereof will be omitted, and the remaining components will be described below.

The positive electrode current collector 112 may include a metal having high electrical conductivity and is not particularly limited as long as it allows the positive electrode active material layer 114 to adhere easily and is non-reactive within the voltage range of the battery. Examples of the positive electrode current collector 112 include stainless steel, aluminum, nickel, titanium, calcined carbon, or aluminum or stainless steel surface-treated with carbon, nickel, titanium, or silver. The positive electrode current collector may typically have a thickness of about 3 μm to 500 μm, and fine unevenness may be formed on the surface of the positive electrode current collector to strengthen the bonding strength of the positive electrode active material. For example, the positive electrode collector may be used in various forms, such as a film, a sheet, a foil, a net, a porous body, a foam, a non-woven body, and the like.

The positive electrode active material layer 114 may optionally include a conductive material and a binder, in addition to the positive electrode active material powder.

In this case, the positive electrode active material powder may be included in an amount of about 80 wt % to 99 wt %, for example, about 85 wt % to 98.5 wt %, based on the total weight of the positive electrode active material layer 114. When included within this range, excellent capacity characteristics may be achieved.

The conductive material used to impart conductivity to the electrode, and it is not particularly limited as long as it has an electrically conductive without causing chemical changes in the battery to be constructed. Examples thereof include graphite such as natural graphite or artificial graphite; carbon-based materials such as carbon black, acetylene black, Ketjen black, channel black, furnace black, lamp black, thermal black, and carbon fiber; metal powder or metal fiber such as copper, nickel, aluminum, and silver; conductive tubes such as carbon nanotube; conductive whiskers such as zinc oxide and potassium titanate; conductive metal oxides such as titanium oxide; or conductive polymers such as polyphenylene derivatives, which may be used alone or in mixture of two or more thereof. The conductive may be included in an amount of about 0.1 wt % to 15 wt % based on the total weight of the electrolyte.

The binder serves to improve the adhesion between positive electrode active material particles and the adhesive strength between the positive electrode active material and the current collector. Examples thereof include polyvinylidene fluoride (PVDF), polyvinylidene fluoride-hexafluoropropylene copolymer (PVDF-co-HFP), polyvinyl alcohol, polyacrylonitrile, polymethyl methacrylate, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene butadiene rubber (SBR), fluororubber, polyacrlic acid, and a polymer in which the hydrogen thereof is substituted with Li, Na, or Ca, or various copolymers thereof, which may be used alone or in mixture of two or more thereof. The binder may be included in an amount of about 0.1 wt % to 15 wt % based on the total weight of the positive electrode active material layer.

The positive electrode 110 may be manufactured according to a conventional positive electrode manufacturing method, except that the above-described positive electrode active material powder is used. For example, the positive electrode may be manufactured by dissolving or dispersing the above-described positive electrode active material powder, and optionally a binder, a conductive agent, and a dispersant in a solvent to prepare a positive electrode slurry composition, coating the slurry onto the positive electrode current collector, followed by drying and rolling.

The solvent may be one that is commonly used in the art, and examples thereof include dimethyl sulfoxide (DMSO), isopropyl alcohol, N-methylpyrrolidone (NMP), dimethyl formamide (DMF), acetone, and water, which may be used either alone or in combination of two or more thereof. The amount of the solvent used is sufficient to dissolve or disperse the positive electrode active material, the conductive agent, the binder, and the dispersant while providing a viscosity that allows for good coating thickness uniformity during electrode manufacturing, taking into account the coating thickness and production yield of the slurry.

Alternatively, the positive electrode 110 may be manufactured by casting the positive electrode slurry composition onto a separate support, peeling off the resulting film from the support, and laminating the film onto the positive electrode current collector 112.

### Electrochemical Device

Next, an electrochemical device (lithium secondary battery) according to the present disclosure is described. An electrochemical device according to the present disclosure includes the above-described positive electrode of the present disclosure. The electrochemical device may be, for example, a battery, a capacitor, or a lithium secondary battery.

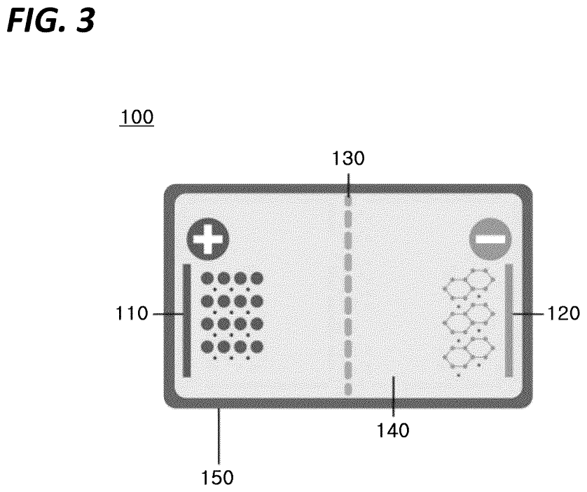

Referring to FIG. 3, the lithium secondary battery 100 may include a positive electrode 110, a negative electrode 120 disposed to face the positive electrode 110, a separator 130 interposed between the positive electrode 110 and the negative electrode 120, and an electrolyte. Since the positive electrode 110 is as described above, repeated description thereof will be omitted, and only the remaining components will be described below.

In addition, the lithium secondary battery 100 may further optionally include a battery case 150 that accommodates an electrode assembly including the positive electrode 110, the negative electrode 120, and the separator 130, and a sealing member for sealing the battery case 150.

In the lithium secondary battery 100, the negative electrode 120 includes a negative electrode current collector and a negative electrode active material layer disposed on the negative electrode current collector.

The negative electrode current collector is not particularly limited as long as it has high conductivity without causing chemical changes in the battery, and examples thereof include copper, stainless steel, aluminum, nickel, titanium, heat-treated carbon, copper or stainless steel surface-treated with carbon, nickel, titanium, or silver, and aluminum-cadmium alloy. The negative electrode current collector may typically have a thickness of about 3 μm to 500 μm, and as in the positive electrode current collector, fine unevenness may be formed on the surface of the current collector to strengthen the bonding strength of the negative electrode active material. For example, the negative electrode collector may be used in various forms, such as a film, a sheet, a foil, a net, a porous body, a foam, a non-woven body, and the like.

The negative electrode active material layer includes a negative electrode active material, and may optionally include a binder and a conductive material.

As the negative electrode active material, a compound capable of reversible intercalation and deintercalation of lithium may be used. Examples thereof include carbon-based materials such as artificial graphite, natural graphite, graphitized carbon fiber, and amorphous carbon; metallic compounds capable of being alloyed with lithium, such as Si, Al, Sn, Pb, Zn, Bi, In, Mg, Ga, Cd, Si alloys, Sn alloys, or Al alloys; metal oxides capable of doping and de-doping lithium, such as SiO_{β} (0<β<2), SnO₂, vanadium oxide, lithium vanadium oxide; or composites containing the above metallic compounds and carbon-based materials, such as Si—C composites or Sn—C composites, and these may be used alone or in a mixture of two or more thereof. Additionally, a metal lithium thin film may also be used as the negative electrode active material. In addition, various types of carbon materials may be used, including both low-crystallinity carbon and high-crystallinity carbon. Representative examples of low-crystallinity carbon include soft carbon and hard carbon. Representative examples of high-crystallinity carbon include high-temperature heat-treated carbon such as natural or artificial graphite in amorphous, plate-shaped, flake-shaped, spherical, or fibrous forms; kish graphite; pyrolytic carbon; mesophase pitch-based carbon fiber; meso-carbon microbeads; mesophase pitches; and petroleum or coal tar pitch derived cokes.

The negative electrode active material may be included in an amount of about 80 wt % to 99 wt % based on the total weight of the negative electrode active material layer.

The binder is a component that assists in the binding between the conductive material, the active material, and the current collector, and is typically added in an amount of about 0.1 wt % to 10 wt % based on the total weight of the negative electrode active material layer. Examples of the binder include polyvinylidene fluoride (PVDF), polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene polymer (EPDM), sulfonated EPDM, styrene-butadiene rubber, nitrile-butadiene rubber, fluorine rubber, and various copolymers thereof.

The conductive material is a component added to further enhance the conductivity of the negative electrode active material, and may be added in an amount of about 10 wt % or less, for example, 5 wt % or less, based on the total weight of the negative electrode active material layer. The conductive material is not particularly limited as long as it has conductivity without causing chemical changes in the battery. Examples thereof include graphite such as natural graphite and artificial graphite; carbon black such as acetylene black, Ketjen black, channel black, furnace black, lamp black, and thermal black; conductive fibers such as carbon fibers or metal fibers; fluorinated carbon; metal powders such as aluminum or nickel powder; conductive whiskers such as zinc oxide or potassium titanate; conductive metal oxides such as titanium oxide; and conductive materials such as polyphenylene derivatives.

The negative electrode active material layer may be formed by applying and drying a negative electrode slurry composition, which is prepared by dissolving or dispersing a negative electrode active material and, optionally, a binder and a conductive material in a solvent, onto the negative electrode current collector. Alternatively, the negative electrode active material layer may be formed by casting the negative electrode slurry composition onto a separate support, peeling off the resulting film from the support, and laminating the film onto the negative electrode current collector.

Meanwhile, in the lithium secondary battery 100, the separator 130 separates the negative electrode 120 from the positive electrode 110 and provides a pathway for lithium-ion migration. Any separator commonly used in lithium secondary batteries may be employed without particular limitation. For example, a material having low resistance to ion migration in the electrolyte and excellent electrolyte absorption capability may be selected. For example, the separator may be a porous polymer film, for example, a porous polymer film made of a polyolefin polymer such as ethylene homopolymer, propylene homopolymer, ethylene/butene copolymer, ethylene/hexene copolymer, and ethylene/methacrylate copolymer, or a laminated structure of two or more layers thereof. In addition, a conventional porous non-woven fabric, for example, a non-woven fabric made of high-melting-point glass fiber, polyethylene terephthalate fiber, etc. may be used. In addition, a coated separator containing a ceramic component or a polymer material may be used to secure heat resistance or mechanical strength, and may be selectively used in a single-layer or multi-layer structure.

In addition, the electrolyte 140 used in the present disclosure may include, but is not limited to, an organic liquid electrolyte, an inorganic liquid electrolyte, a solid polymer electrolyte, a gel-type polymer electrolyte, a solid inorganic electrolyte, a molten inorganic electrolyte, and the like that may be used in the manufacture of a lithium secondary battery 100.

According to one embodiment, the electrolyte 140 may include an organic solvent and a lithium salt.

As the organic solvent, any solvent capable of acting as a medium through which ions involved in the electrochemical reaction of the battery may migrate may be used without particular limitation. Examples of the organic solvent include ester solvents such as methyl acetate, ethyl acetate, γ-butyrolactone, and ε-caprolactone; ether solvents such as dibutyl ether or tetrahydrofuran; ketone solvents such as cyclohexanone; aromatic hydrocarbon solvents such as benzene and fluorobenzene; carbonate solvents such as dimethyl carbonate (DMC), diethyl carbonate (DEC), methyl ethyl carbonate (MEC), ethyl methyl carbonate (EMC), ethylene carbonate (EC), and propylene carbonate (PC); alcohol solvents such as ethyl alcohol and isopropyl alcohol; nitriles such as R—CN (R is a linear, branched, or cyclic hydrocarbon group having 2 to 20 carbon atoms, which may include a double-bonded aromatic ring or an ether bond); amides such as dimethylformamide; dioxolanes such as 1,3-dioxolane; and sulfolanes. Among these, a carbonate solvent may be used, and a mixture of a cyclic carbonate having high ionic conductivity and high dielectric constant capable of improving charge/discharge performance of the battery (e.g., ethylene carbonate or propylene carbonate) and a low-viscosity linear carbonate compound (e.g., ethyl methyl carbonate, dimethyl carbonate, or diethyl carbonate) may be used.

The lithium salt may be used without any particular limitations as long as it is a compound capable of providing lithium ions used in a lithium secondary battery. For example, the anion of the lithium salt may be at least one selected from F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻, and the lithium salt may be at least one selected from LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, and LiB(C₂O₄)₂. The concentration of the lithium salt may be used within the range of about 0.1 M to 2.0 M. When the concentration of the lithium salt falls in the above range, the electrolyte 140 has appropriate conductivity and viscosity, so that the excellent electrolyte performance may be achieved, and the lithium ions may effectively migrate.

In addition to the electrolyte components, the electrolyte 140 may further contain one or more additives, such as, for example, haloalkylene carbonate compounds such as difluoroethylene carbonate, pyridine, triethylphosphite, triethanolamine, cyclic ethers, ethylene diamine, n-glyme, hexaphosphoric acid triamide, nitrobenzene derivatives, sulfur, quinone imine dyes, N-substituted oxazolidinones, N,N-substituted imidazolidines, ethylene glycol dialkyl ethers, ammonium salts, pyrrole, 2-methoxy ethanol, or aluminum trichloride, for the purpose of improving the life characteristics of the battery, suppressing battery capacity decrease, and improving the discharge capacity of the battery. In this case, the additive 140 may be contained in an amount of about 0.1 wt % to 5 wt % based on the total weight of the electrolyte.

Meanwhile, the lithium secondary battery 100 according to one embodiment of the present disclosure may be manufactured in, for example, a prismatic type, a pouch type, or cylindrical, depending on the form to be manufactured.

Hereinafter, embodiments of the present disclosure are described in detail to enable one of ordinary skill in the art to which the present disclosure belongs, to easily practice the present disclosure. However, the present disclosure may be implemented in many different forms and is not limited to the embodiments described herein.

### Example 1

A positive electrode active material precursor having a composition of Ni_{0.65}Co_{0.07}Mn_{0.28}(OH)₂ and a specific surface area (BET) of 27 m²/g was prepared. The positive electrode active material precursor and Li₂CO₃ were mixed such that the molar ratio of total transition metals to lithium was 1:1.06, and then calcined at 910° C. for 23 hours under an oxygen atmosphere to prepare a positive electrode active material having a composition of Li_{1.06}Ni_{0.65}Co_{0.07}Mn_{0.28}O₂. In this case, the oxygen atmosphere during calcination was a condition in which the volume ratio of O₂ to air was 8:2.

As a result of TEM analysis of the positive electrode active material of Example 1 thus prepared, the ratio of the (003) plane to the total surface area was 22%.

### Example 2

A positive electrode active material precursor having a composition of Ni_{0.65}Co_{0.07}Mn_{0.28}(OH)₂ and a specific surface area (BET) of 19 m²/g was prepared. The positive electrode active material precursor and Li₂CO₃ were mixed such that the molar ratio of total transition metals to lithium was 1:1.08, and then calcined at 910° C. for 23 hours under an oxygen atmosphere to prepare a positive electrode active material having a composition of Li_{1.08}Ni_{0.65}Co_{0.07}Mn_{0.28}O₂. In this case, the oxygen atmosphere during calcination was a condition in which the volume ratio of O₂ to air was 8:2.

As a result of TEM analysis of the positive electrode active material of Example 2 thus prepared, the ratio of the (003) plane to the total surface area was 37%.

### Example 3

A positive electrode active material precursor having a composition of Ni_{0.65}Co_{0.07}Mn_{0.28}(OH)₂ and a specific surface area (BET) of 27 m²/g was prepared. The positive electrode active material precursor and Li₂CO₃ were mixed such that the molar ratio of total transition metals to lithium was 1:1.06, and then calcined at 870° C. for 19 hours under an oxygen atmosphere to prepare a positive electrode active material having a composition of Li_{1.08}Ni_{0.65}Co_{0.07}Mn_{0.28}O₂. In this case, the oxygen atmosphere during calcination was a condition in which the volume ratio of O₂ to air was 8:2.

As a result of TEM analysis of the positive electrode active material of Example 3 thus prepared, the ratio of the (003) plane to the total surface area was 32%.

### Comparative Example 1

A positive electrode active material precursor having a composition of Ni_{0.65}Co_{0.07}Mn_{0.28}(OH)₂ and a specific surface area (BET) of 9 m²/g was prepared. The positive electrode active material precursor and Li₂CO₃ were mixed such that the molar ratio of total transition metals to lithium was 1:1.10, and then calcined at 870° C. for 19 hours under an oxygen atmosphere to prepare a positive electrode active material having a composition of Li_{1.10}Ni_{0.65}Co_{0.07}Mn_{0.28}O₂. In this case, the oxygen atmosphere during calcination was a condition in which the volume ratio of O₂ to air was 8:2.

As a result of TEM analysis of the positive electrode active material of Comparative Example 1 thus prepared, the ratio of the (003) plane to the total surface area was 64%.

### Comparative Example 2

A positive electrode active material precursor having a composition of Ni_{0.65}Co_{0.07}Mn_{0.28}(OH)₂ and a specific surface area (BET) of 9 m²/g was prepared. The positive electrode active material precursor and Li₂CO₃ were mixed such that the molar ratio of total transition metals to lithium was 1:1.03, and then calcined at 870° C. for 19 hours under an oxygen atmosphere to prepare a positive electrode active material having a composition of Li_{1.03}Ni_{0.65}Co_{0.07}Mn_{0.28}O₂. In this case, the oxygen atmosphere during calcination was a condition in which the volume ratio of O₂ to air was 8:2.

As a result of TEM analysis of the positive electrode active material of Comparative Example 2 thus prepared, the ratio of the (003) plane to the total surface area was 85%.

Referring to Examples and Comparative Examples, it can be seen that the proportions of the (003) plane in Examples 1 to 3 are 22%, 37%, and 32%, respectively, which are all 40% or less. In contrast, in Comparative Examples 1 and 2, the proportions of the (003) plane are 64% and 85%, respectively, which are 40% or more.

### Experimental Example 1—Observation of TEM Images of Positive Electrode Active Material Particles

Cross-sectional images of the positive electrode active materials prepared in Examples 1 to 3 and Comparative Examples 1 and 2 were taken using a TEM (Transmission Electron Microscope).

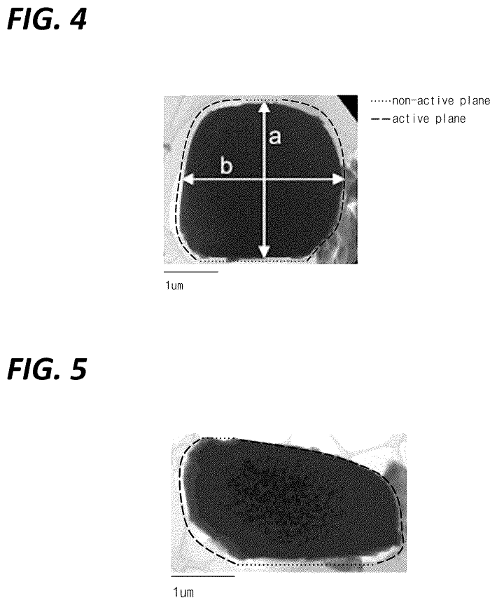

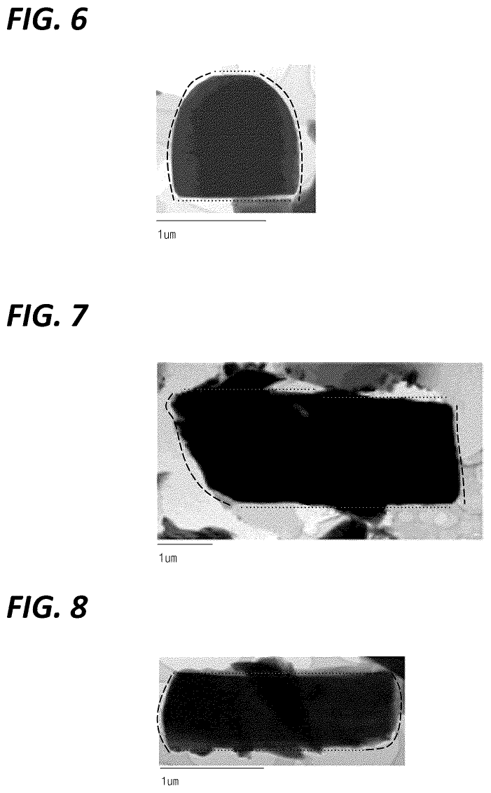

For example, in the cross-sectional TEM images, the short-axis and long-axis lengths of 300 particles were measured, and the ratio of the long axis to the short axis (e.g., the a/b value in FIG. 4) was calculated for each. Representative examples of the results are illustrated in FIGS. 4 to 8. In addition, the arithmetic average values of the measured long-to-short axis ratios are shown in Table 1 below.

TABLE 1

| | Ratio of long axis to short axis |
|---|---|
| Example 1 | 1.31 |
| Example 2 | 1.52 |
| Example 3 | 1.34 |
| Comparative Example 1 | 2.07 |
| Comparative Example 2 | 2.23 |

Referring to Table 1, in Examples 1 to 3, the ratios of the long axis to the short axis were 1.31, 1.52, and 1.34, respectively, which fall within the range of 1 to 1.8. In contrast, in Comparative Examples 1 and 2, the ratios were 2.07 and 2.23, respectively, which are 2 or higher.

In addition, FIGS. 4 to 8 distinguish between non-active planes and active planes. The non-active plane is the (003) plane, while the active planes are the (102) and (104) planes.

### Experimental Example 2—Measurement of Powder Resistance of Positive Electrode Active Material

The powder resistance of each of the positive electrode active materials prepared in Examples 1 to 3 and Comparative Examples 1 and 2 was measured using a powder resistance measuring apparatus (HPRM-1000, Hantech Co., Ltd.). Specifically, 5 g of each of the positive electrode active materials prepared in Examples 1 to 3 and Comparative Examples 1 and 2 was placed into a cylindrical metal mold in the HPRM-1000 apparatus, and a pressure of 2,000 kgf/cm² was applied to measure the powder resistance. The measured powder resistance values are shown in Table 2 below.

TABLE 2

| | Power resistance (Ω) |
|---|---|
| Example 1 | 0.00033 |
| Example 2 | 0.00023 |
| Example 3 | 0.00029 |
| Comparative Example 1 | 0.00013 |
| Comparative Example 2 | 0.00009 |

Referring to Table 2, the powder resistances of Examples 1 to 3 were 0.00033 Ω, 0.00023Ω, and 0.00029Ω, respectively, which are all within the range of 0.00005Ω to 0.0005Ω. In contrast, the powder resistances of Comparative Examples 1 and 2 were 0.00013Ω and 0.0009Ω, the latter of which exceeds 0.0005Ω.

### Experimental Example 3—Measurement of Initial Resistance

A positive electrode slurry was prepared by mixing the positive electrode active material prepared in Examples 1 to 3 and Comparative Examples 1 and 2, carbon black as a conductive material, and polyvinylidene fluoride (PVdF) as a binder in N-methylpyrrolidone (NMP) solvent at a weight ratio of 96:2:2. The slurry was then applied to one surface of an aluminum current collector, dried at 130° C., and roll-pressed to manufacture a positive electrode.

Lithium metal was used as the negative electrode.

A porous polyethylene separator was interposed between the negative electrode and the positive electrode prepared as described above to prepare an electrode assembly. The electrode assembly was placed inside a battery case, and an electrolyte was injected into the case to manufacture a lithium secondary battery. The electrolyte was prepared by dissolving 1.0 M lithium hexafluorophosphate (LiPF₆) and 2 wt % VC (vinylene carbonate) in an organic solvent made up of a mixture of ethylene carbonate (EC), dimethyl carbonate (DMC), and diethyl carbonate (DEC) in a volume ratio of 1:2:1.

For each of the lithium secondary battery cells prepared as described above, the initial resistance was measured. The measurement results are indicated in Table 3 below. The initial resistance was calculated based on the rate of voltage change when a current of 2.5 C was applied for 10 seconds at 50% SOC during the second cycle, using the discharge capacity at 0.3 C in the first cycle as the reference.

TABLE 3

| | Initial resistance (Ω) |
|---|---|
| Example 1 | 1.36 |
| Example 2 | 1.52 |
| Example 3 | 1.34 |
| Comparative Example 1 | 2.07 |
| Comparative Example 2 | 2.23 |

Referring to Table 3, the initial resistances of Examples 1 to 3 were 1.36Ω, 1.52Ω, and 1.34Ω, respectively, whereas those of Comparative Examples 1 and 2 were 2.07Ω and 2.23Ω, respectively, which were higher than those of the Examples.

### Experimental Example 4—Measurement of Life Characteristics

For each lithium secondary battery cell manufactured in Experimental Example 3, charging was performed at 45° C. with a constant current of 0.5 C up to 4.45 V with a cut-off of 0.05 C. Subsequently, discharging was performed at a constant current of 0.5 C until the voltage reached 3.0 V. One cycle was defined as the charging and discharging behavior, and this cycle was repeated 100 times. Afterward, capacity retention rate and resistance increase rate were measured based on the number of cycles. The capacity retention rate was calculated by dividing the capacity at the 100th cycle by the initial capacity and multiplying the result by 100. The resistance increase rate was calculated by dividing the resistance at the 100th cycle by the initial resistance and multiplying the result by 100. The results are indicated in Table 4 below.

TABLE 4

| | Capacity retention | Resistance increase |
|---|---|---|
| | rate (%) | rate (%) |
| Example 1 | 93.3 | 32.0 |
| Example 2 | 90.5 | 34.2 |
| Example 3 | 92.7 | 33.9 |
| Comparative Example 1 | 89.9 | 36.4 |
| Comparative Example 2 | 85.1 | 53.7 |

Referring to Table 4, the capacity retention rates of Examples 1 to 3 were 93.3%, 90.5%, and 92.7%, respectively, whereas those of Comparative Examples 1 and 2 were 89.9% and 85.1%, respectively, which were lower than those of Examples 1 to 3. In addition, the resistance increase rates of Examples 1 to 3 were 32.0%, 34.2%, and 33.9%, respectively, while those of Comparative Examples 1 and 2 36.4% and 53.7%, respectively, which were higher than those of Examples 1 to 3.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A positive electrode active material comprising a lithium transition metal oxide including Ni in an amount of about 60 at % or more among the transition metals excluding lithium, in a form of a single particle made up of one nodule or in a form of a pseudo-single particle that is a complex of 30 or fewer nodules,
wherein a proportion of a (003) plane with respect to a total surface area of the positive electrode active material is 40% or less.

2. The positive electrode active material according to claim 1, wherein a ratio of a major axis to a minor axis of particles of the positive electrode active material is about 1.0 to 1.8.

3. The positive electrode active material according to claim 1, wherein the lithium transition metal oxide has a composition represented by Formula 1:
$$L {i}_{a} {Ni}_{b} {Co}_{c} {M}_{d}^{1} {M}_{e}^{2} {O}_{2} \qquad [ Formula 1 ]$$
wherein, M¹ is Mn, Al, or a combination thereof; M² is at least one selected from Zr, W, Y, Ba, Ca, Ti, Mg, Ta, and Nb; and a, b, c, d, and e satisfy 0.8≤a≤1.2, 0.6≤b<1, 0<c<0.4, 0<d<0.4, 0≤e≤0.1.

4. The positive electrode active material according to claim 1, wherein a proportion of a (102) plane with respect to the total surface area of the positive electrode active material is about 20% to 80%.

5. The positive electrode active material according to claim 1, wherein a proportion of a (104) plane with respect to the total surface area of the positive electrode active material is about 20% to 80%.

6. The positive electrode active material according to claim 1, wherein a powder resistance of the positive electrode active material is about 0.00005Ω to 0.0005 Ω.

7. The positive electrode active material according to claim 1, wherein an average particle diameter D₅₀ of the positive electrode active material is about 2 μm to 8 μm.

8. The positive electrode active material according to claim 1, wherein a specific surface area BET of the positive electrode active material is about 0.3 m²/g to 1.2 m²/g.

9. The positive electrode active material according to claim 1, wherein a tap density of the positive electrode active material is about 1.5 g/cm³ to 2.9 g/cm³.

10. A positive electrode comprising the positive electrode active material of claim 1.

11. A lithium secondary battery comprising the positive electrode of claim 10.

12. A method of preparing a positive electrode active material including a lithium transition metal oxide including Ni in an amount of about 60 at % or more among the transition metals excluding lithium, in a form of a single particle made up of one nodule or in a form of a pseudo-single particle that is a complex of 30 or fewer nodules,
the method comprising:
adjusting a proportion of a (003) plane with respect to a total surface area of the positive electrode active material to 40% or less.

13. The method according to claim 12, wherein a ratio of a major axis to a minor axis of particles of the positive electrode active material is adjusted to about 1.0 to 1.8.

14. The method according to claim 12, wherein the lithium transition metal oxide has a composition represented by Formula 1:
$$L {i}_{a} {Ni}_{b} {Co}_{c} {M}_{d}^{1} {M}_{e}^{2} {O}_{2} \qquad [ Formula 1 ]$$
wherein, M¹ is Mn, Al, or a combination thereof; M² is at least one selected from Zr, W, Y, Ba, Ca, Ti, Mg, Ta, and Nb; and a, b, c, d, and e satisfy 0.8≤a≤1.2, 0.6≤b<1, 0<c<0.4, 0<d<0.4, 0≤e≤0.1.
